(19) United States
(12) Patent Application Publication
(10) Pub. No.: US 2025/0379339 A1
(43) Pub. Date: Dec. 11, 2025

(54) CURRENT COLLECTOR PLATES FOR BATTERIES

(71) Applicant: OLA ELECTRIC MOBILITY LIMITED, Bangalore (IN)

(72) Inventors: Nirmal THANGAPPAN, Bangalore (IN); Arunabh GHOSH, Bangalore (IN)

(21) Appl. No.: 18/683,061

(22) PCT Filed: Apr. 18, 2023
(86) PCT No.: PCT/IN2023/050373

§ 371 Date: Feb. 12, 2024

(30) Foreign Application Priority Data
Mar. 1, 2023 (IN) 202341013892

(51) Int. Cl. H01M 50/533; H01M 10/04; H01M 50/528; H01M 50/534

(52) U.S. Cl. CPC H01M 50/533; H01M 10/0431; H01M 50/528; H01M 50/534

(57) ABSTRACT

A current collector plate includes a frame member having at least two arms. The at least two arms are arranged radially on the frame member to define two or more slots in the frame member. The current collector plate includes two or more flap members coupled to the inner periphery of the frame member and positioned in the two or more slots without being in contact with the at least two arms. Each flap member is in a plane different from the plane in which the frame member lies.

### BACKGROUND

Secondary batteries offer various advantages, including a high operation voltage, a high energy density per unit weight, and therefore, are being widely used as power supplies in portable electronic devices and hybrid automobiles or electric vehicles. A secondary battery may be classified as a cylindrical type, a prismatic type, or a pouch type. Generally, a cylindrical secondary battery includes an electrode assembly, a casing to accommodate the electrode assembly, an electrolyte injected into the casing, and a cap assembly coupled to one side of the casing to prevent separation of the electrode assembly.

### BRIEF DESCRIPTION OF FIGURES

The detailed description is provided with reference to the accompanying figures, wherein:

FIG. 1 illustrates an exploded view of a battery, according to an example;

FIG. 2 illustrates a perspective view of a current collector plate of a battery, according to an example; and

FIG. 3 illustrates a cross-sectional view of the current collector plate, according to another example.

### DETAILED DESCRIPTION

Conventional cylindrical secondary batteries include a jelly roll type electrode assembly. The jelly roll is prepared by winding a foil or sheet of a positive electrode and a negative electrode with a separator interposed therebetween. The positive electrode is a positive active material, such as layered metal oxides coated on a conductive foil, such as an aluminium foil. The negative electrode is a negative active material, such as Graphite coated on a conductive foil, such as a copper foil. Thereafter, the electrode assembly is placed inside a casing and a cap assembly having an external terminal is mounted on the casing. Further, conductive tabs are attached to the positive and negative electrodes to collect electric current generated by the electrode assembly.

Nowadays, the secondary cells are developed where instead of separate conductive tabs, current collector foils which are not coated with an active material act as tabs. Once the electrode assembly, such as a jelly roll is winded, a positive current collector plate and a negative current collector plate is welded to the positive tab and the negative tab respectively. Thereafter, the electrode assembly is put into the casing that is pre-assembled with a rivet on a top side. The positive current collector plate is welded to the rivet and the negative current collector plate is welded to the side wall of the casing to close the casing.

In the existing techniques, as the components, such as the positive and negative current collector plates are tightly packed, any variations in the dimensions of the electrode assembly may compromise an overall assembly of the secondary cell. For example, if the electrode assembly is longer than a designed height, the positive current collector plate may hit against the rivet and the negative current collector plate may not be in physical contact with the side wall of the casing. As a result, attaching the negative current collector plate to the side wall of the casing may become a challenge. In a similar manner, if the electrode assembly is shorter than the designed height, the negative current collector plate may sit against the wall of the casing, but there may not be any physical contact between the positive current collector plate and the rivet for attachment purposes.

The present subject matter describes example current collector plates and batteries having such a current collector plate. In the example current collector plates described herein, the variation in planes of different components of the current collector plates may facilitate in accommodating height tolerances of the electrode assembly.

In accordance with the present subject matter, a current collector plate of a battery includes a frame member. The frame member defines a boundary of the current collector plate. Further, the frame member includes at least two arms converging from an inner surface of the frame member towards a center of the frame member. The at least two arms divide an inner area of the frame member into two or more slots.

In addition, the current collector plate includes two or more flap members coupled to the inner periphery of the frame member. The two or more flap members are positioned in the two or more slots without being in contact with the at least two arms. Further, each of the two or more flap members are in a plane different from the plane in which the frame member lies.

According to the present subject matter, the two or more flap members are welded to the electrode assembly, before inserting the electrode assembly in the casing. As the two or more flap members are only connected to the frame member from one side, the two or more flap members are configured to accommodate any height variations of the electrode assembly. For example, to accommodate more height of the electrode assembly than a desired height, the two or more flap members may be pushed upwards towards the plane of the frame member without causing changes in the size of the casing.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

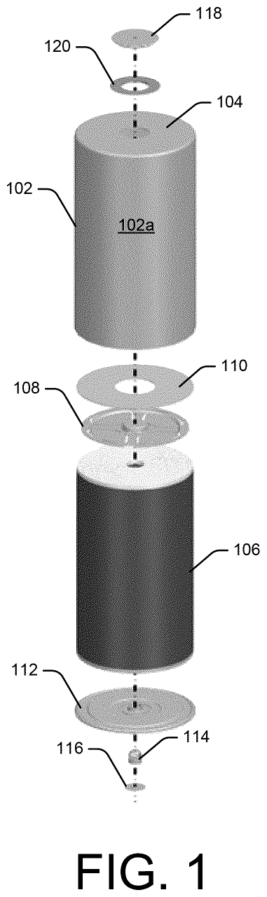

The manner in which the present subject matter is implemented are explained in detail with respect to FIGS. 1-3. While aspects of described subject matter can be implemented in any number of different devices, environments, and/or implementations, the examples are described in the context of the following system(s). It is to be noted that drawings of the present subject matter shown here are for illustrative purposes and are not drawn to scale.

FIG. 1 illustrates an exploded view of a battery 100, such as a secondary battery, according to an example. The battery 100 includes a casing 102. The casing 102 may be made of a conductive metal, e.g., aluminum, an aluminum alloy or nickel-coated steel. The casing 102 as depicted in FIG. 1 is formed in a cylindrical shape having a cylindrical wall 102a of a predetermined diameter. The casing 102 has a closed end 104 and an open end (not shown).

The battery 100 further includes an electrode assembly 106, such as a jelly roll. The electrode assembly 106 includes a first electrode (not shown) and a second electrode (not shown) with a separator layer (not shown) interposed between the first electrode and the second electrode. Thereafter, the first electrode, the separator layer, and the second electrode are wound around a core (not shown).

The electrode assembly 106 is thereafter electrically connected to a current collector plate 108 at one end. The current collector plate 108 may act as a bridging component to collect electrical current generated at the electrode assembly 106 and connect with an external terminal. In the present subject matter, the current collector plate 108 is connected to an uncoated portion of the positive electrode, such as an electrode foil. The current collector plate 108 includes a stepped structure to facilitate adjusting any height variations of the electrode assembly 106 without altering remaining aspects of the battery 100. For example, when the current collector plate 108 is attached to the electrode assembly 106, only a portion of the current collector plate 108 is in contact with the electrode assembly 106. This portion is capable of being pressed or flexed based on a height of the electrode assembly 106.

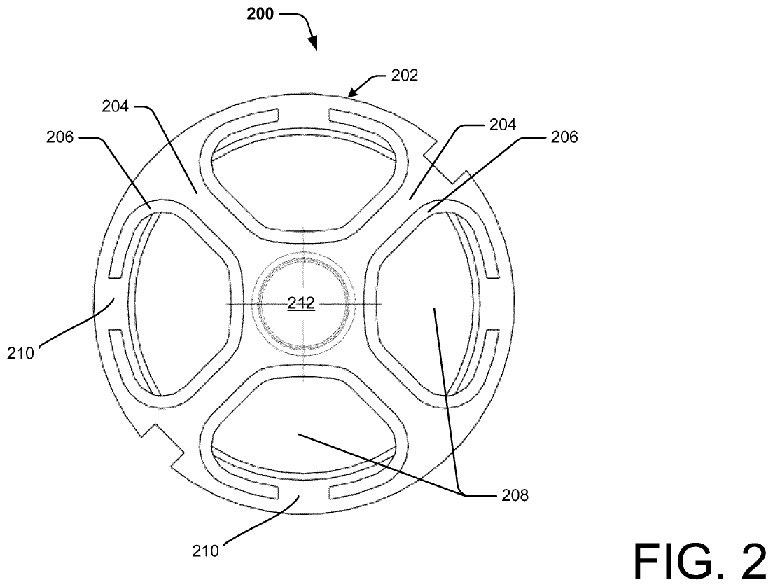

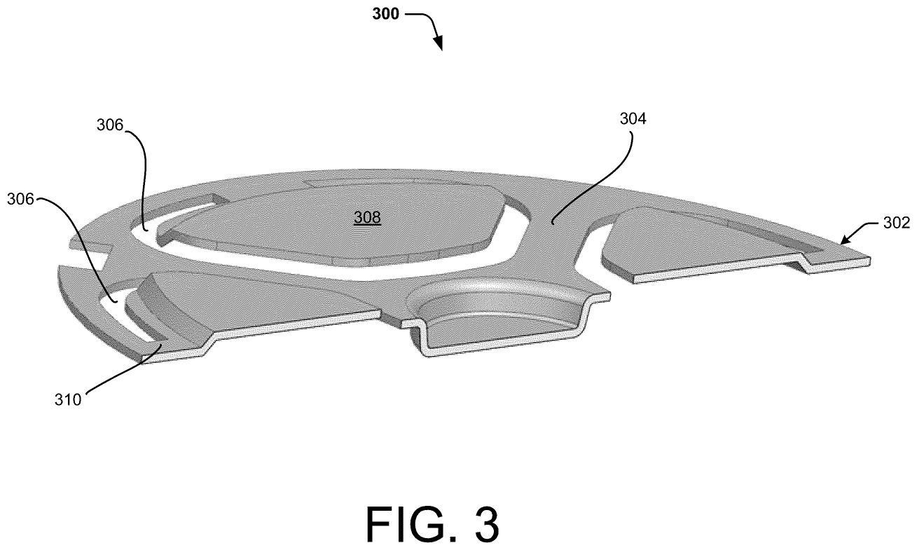

Details with respect to the current collector plate 108 are provided in details in conjunction with FIGS. 2 and 3. Although the current collector plate 108 is depicted in FIG. 1 as a cathode plate, it may be understood that the current collector plate 108 may be implemented as an anode plate or both as a cathode plate and an anode plate.

In addition, an insulating disc or a gasket 110 is mounted on the current collector plate 108, before the electrode assembly 106 is inserted inside the casing 102 through the open end. The insulating disc 110 is therefore disposed between the current collector plate 108 and an inner surface of the closed end 104 of the casing 102. Further, the open end of the casing 102 is closed with a bottom plate 112 to hold the electrode assembly 106 in the casing 102. The bottom plate 112 is attached with the casing 102 in such a manner that the bottom plate 112 is in contact with the negative electrode of the electrode assembly 106. As a circumferential edge of the bottom plate 112 is aligned with the side wall 102a of the casing 102, the casing 102 and in turn a top surface of the closed end 104 acts as a negative terminal of the battery 100. The bottom plate 112 is further sealed with the casing 102 by a sealing rubber 114 and a closing pin 116.

In addition, the battery 100 includes a rivet 118 attached to the closed end 104 of the casing 102 through a rivet gasket 120. The rivet 118 is welded to the cathode current collector plate 108. As a result, the rivet 118 acts as a positive terminal of the battery 100. The rivet gasket 120 provides a hermetic sealing between the rivet 118 and the closed end 104 of the casing 102. The rivet gasket 120 provides electrical insulation between opposite terminals of the battery 100.

FIG. 2 illustrates a perspective view of a current collector plate 200, in accordance with an example. Although the current collector plate 200 as depicted in FIG. 2 has a substantially circular shape, the current collector plate 200 may have any suitable shape based on a shape of an electrode assembly on which the current collector plate 200 is to be mounted. The current collector plate 200 is similar to the current collector plate 108.

The current collector plate 200 includes a frame member 202 that defines a boundary of the current collector plate 200. The frame member 202 includes at least two arms 204 that converge from an inner surface of the frame member 200 towards a center of the frame member. The at least two arms 204 are arranged radially on the frame member 200. The at least two arms 204 divide an inner area of the frame member 202 to define two or more slots 206 in the frame member 202.

Further, the current collector plate 200 includes two or more flap members 208. The flap members 208 are connected to an inner periphery 210 of the frame member 202. It will be evident to a person skilled in the art that the number of flap members corresponds to the number of slots in the frame member 202. In the present subject matter, the two or more flap members 208 are positioned in the two or more slots 206 without being in contact with the at least two arms 204 of the frame member 202. In the current collector plate 200 of the present subject matter, the two or more flap members 208 are in a plane different from the plane in which the frame member 202 lie. For example, a plane of the two or more flap members 208 is lower than the plane of the frame member 202, thereby creating a step or a height difference between the frame member 202 and the two or more flap members 208.

In an implementation, the current collector plate 200 includes a protruding member 212 formed about the center of the frame member 202. In an example, the protruding member 212 fits under a hollow rivet of a battery, such as the battery 100. In an example, each of the two or more flap members 208 are in a plane different from the plane in which the protruding member 212 lies. Thus, the frame member 202, the two or more flap members 208, and the protruding member 212 all lie in different planes with respect to each other.

The above-described structure of the current collector plate 200 allows the two or more flap members 208 to adjust with respect to an electrode assembly with which the two or more flap members 208 are attached. While mounting the current collector plate 200 on the electrode assembly, the two or more flap members 208 are welded to an uncoated portion of the electrode assembly by laser welding. In an example, a cathode current collector plate made as per the present subject matter is welded to an uncoated portion of the cathode foil and an anode current collector plate is welded to an uncoated portion of the anode foil.

For example, when the height of the electrode assembly is more than desired, when the electrode assembly is welded to the two or more flap members 208, the two or more flap members 208 may get stretched in an upward direction. Such a movement of the flap members 208 with respect to the frame member 202 is possible due to the different planes of the flap members 208 and the frame member 202. This allows the anode current collector plate to be in contact with the side wall of the casing for welding.

FIG. 3 illustrates a cross-sectional view of the current collector plate 300, according to another example. The current collector plate 300 is similar to the current collector plates 108 and 200. In the present implementation, the current collector plate 300 has a thickness in a range of about 0.4 millimetres (mm) to about 1 mm. Further, the current collector plate 300 may be made of an aluminium material, a stainless-steel material, or a copper material.

The current collector plate 300 includes a frame member 302 having at least two arms 304. The at least two arms 304 create at least two slots 306 in an inner area of the frame member 302. In an example, each of the at least two arms 204 has a width of about 2.5 millimetres (mm).

Further, the frame member 302 includes two or more flap members 308 positioned in the two or more slots 306 without being in contact with the arms. As described with reference to FIG. 2, the two or more flap members 308 are in a plane different from the plane of the frame member 302, the frame member 302 includes a step or a height difference between an inner periphery 310 of the frame member 302 and the two or more flap members 308.

Although aspects for the present disclosure have been described in a language specific to structural features and/or methods, it is to be understood that the appended claims are not limited to the specific features or methods described herein. Rather, the specific features and methods are disclosed as examples of the present disclosure.

1. A current collector plate for being configured to be connected to an electrode assembly of a battery, the current collector plate comprising:
a frame member having at least two arms converging from an inner periphery of the frame member towards a center of the frame member to define two or more slots in the frame member; and
two or more flap members coupled to the inner periphery of the frame member and positioned in the two or more slots without being in contact with the at least two arms, wherein each of the two or more flap members are in a plane different from the plane in which the frame member lies.

2. The current collector plate as claimed in claim 1, wherein a plane of the two or more flap members is lower than a plane of the frame member.

3. The current collector plate as claimed in claim 2, wherein current collector plate includes a step between each of the two or more flap members and the frame member.

4. The current collector plate as claimed in claim 1, wherein the at least two arms are arranged radially on the frame member.

5. The current collector plate as claimed in claim 1, wherein the current collector plate comprises a protruding member formed about the center of the frame member.

6. The current collector plate as claimed in claim 5, wherein each of the two or more flap members are in a plane different from a plane in which the protruding member lies.

7. The current collector plate as claimed in claim 1, wherein the current collector plate is made of one of an aluminium material, a stainless-steel material, or a copper material.

8. The current collector plate as claimed in claim 1, wherein the current collector plate has a thickness in a range of about 0.4 millimetres (mm) to about 1 mm.

9. A battery comprising:
a casing;
an electrode assembly comprising at least a positive electrode and a negative electrode, the electrode assembly is positioned within the casing; and
a current collector plate connected to one of the positive electrode and the negative electrode, wherein the current collector plate comprises:
a frame member having at least two arms converging from an inner periphery of the frame member towards a center of the frame member to define two or more slots in the frame member; and
two or more flap members coupled to the inner periphery of the frame member and positioned in the two or more slots without being in contact with the at least two arms, wherein each of the two or more flap members are in a plane different from the plane in which the frame member lies,
wherein the electrode assembly is connected to the current collector plate by the two or more flap members before being positioned inside the casing.

10. The battery as claimed in claim 9, wherein a plane of the two or more flap members is lower than a plane of the frame member.

11. The battery as claimed in claim 10, wherein current collector plate includes a step between each of the two or more flap members and the frame member.

12. The battery as claimed in claim 9, wherein the electrode assembly is a jellyroll type electrode assembly.

13. The battery as claimed in claim 9, wherein the current collector plate comprises a protruding member formed about the center of the frame member.

14. The battery as claimed in claim 13, wherein each of the two or more flap members are in a plane different from a plane in which the protruding member lies.
